(19) United States
(12) Patent Application Publication
(10) Pub. No.: US 2018/0108444 A1
(43) Pub. Date: Apr. 19, 2018

(54) ULTRAVIOLET (UV) LIGHT INHIBITING APPARATUS AND SYSTEM

(71) Applicant: Ultra V Coating, LLC, Batavia, OH (US)

(72) Inventor: Shawn A. Coons, Milford, OH (US)

(21) Appl. No.: 15/294,972

(22) Filed: Oct. 17, 2016

(51) Int. Cl. G21F 3/00; B05D 3/06

(52) U.S. Cl. CPC G21F 3/00; B05D 3/067

(57) ABSTRACT

An Ultraviolet light inhibiting apparatus is adapted to be attached to a UV curing device on a front-right or front-left portion of the UV curing device. When attached, the UV light inhibiting apparatus shields at least a portion of UV light illuminated from UV bulbs of the UV curing device.

### BACKGROUND

Curing Ultraviolet (UV) coatings on surfaces (such as flooring) typically requires a substantial amount of heat energy, UV curing lamps can provide such heat. Typically, a UV bulb includes mercury that is heated into a plasma, and the surface of the UV bulb can reach temperatures between 700-900 degrees Celsius (1292-1652 degrees Fahrenheit. These bulbs can be placed side-by-side one another in UV curing devices (requiring a substantial amount of voltage). The UV curing devices can produce heat in the reflected light that can burn and blister an operator's skin.

UV coatings on floors provide superior floor strength and durability, such that in some cases the UV coating is stronger than the flooring on which it is coated (such as concrete). The UV coating also creates a visibly appealing gloss or finish on the flooring. If the UV coating is not cured properly, then the coated surface creates seams, zippers, or blisters. This appearance is unsightly and can create flooring hazards in the area of the seams where the coating makes the surface of the floor uneven. Once a pass is made with a UV curing device on the UV coating that creates a seam, the seam cannot be removed without sanding the coating off (very difficult given the strength of the coating), reapplying a new coating, and re-curing the new coating.

The zippering effect during the curing process is largely due to the leakage of UV light from the bottom of the UV curing device where a space exists between the UV bulbs and the surface that is being cured. UV curing device manufacturers cannot practically reduce this space because hardly any surface is truly level. Consequently, when an operator is curing the UV coating on the surface, UV light leaks from the sides of the UV curing device that partially cures a coating along the sides of the UV curing device. This makes elimination of zippering very difficult and in some situations nearly impossible for the operator.

Many enterprises would prefer UV coated flooring, but because existing UV curing devices and the existing UV curing processes make the curing process so laborious and fraught with errors (seams), most enterprises have not attempted UV coating flooring. Additionally, few service organizations can be hired by enterprises to apply UV coatings when enterprises are interested in UV coating applications to their flooring. This is largely because the service organizations will not warranty the finished curing or will only do so at unreasonable prices to the enterprises.

Consequently, market acceptance of UV surface coatings has not occurred to any significant degree even though UV coatings provide superior surface protection to other existing types of surface coatings and even though UV curing devices are available in the market for curing the UV coatings onto the surfaces.

### SUMMARY

In various embodiments, techniques, apparatuses, devices, and systems for applying UV coatings on surfaces are presented.

Specifically, and in an embodiment, an apparatus is provided. The apparatus includes: a) a UV shielding apparatus adapted to attach to a front and left-side corner of a UV curing device and cover a first portion of UV bulbs, and b) a second UV shielding apparatus adapted to attach to a front and right-side corner of the UV curing device and cover a second portion of the UV bulbs.

### BRIEF DESCRIPTION OF THE DRAWINGS

FIG. 1A is front and side view of a UV light inhibiting (shielding) apparatus, according to an example embodiment.

FIG. 1B is a different view of the UV light inhibiting apparatus from that which is shown in the FIG. 1A, according to an example embodiment.

FIG. 2A is a view of UV light inhibiting apparatuses attached to the sides of a UV curing device with a bottom perspective of the UV curing apparatus, according to an example embodiment.

FIG. 2B is a view of one the UV light inhibiting apparatus attached to one corner side of a UV curing device with top-down perspective of the UV curing device, according to an example embodiment.

FIG. 3A is a diagram of a UV curing device having two attached the UV light inhibiting apparatuses, according to an example embodiment.

FIG. 3B is a diagram of another UV curing device having two attached the UV light inhibiting apparatuses, according to an example embodiment.

FIG. 4 is a diagram of a system for using UV light inhibiting apparatuses attached or integrated into a UV curing device to cure a UV coating on a surface, according to an example embodiment.

### DETAILED DESCRIPTION

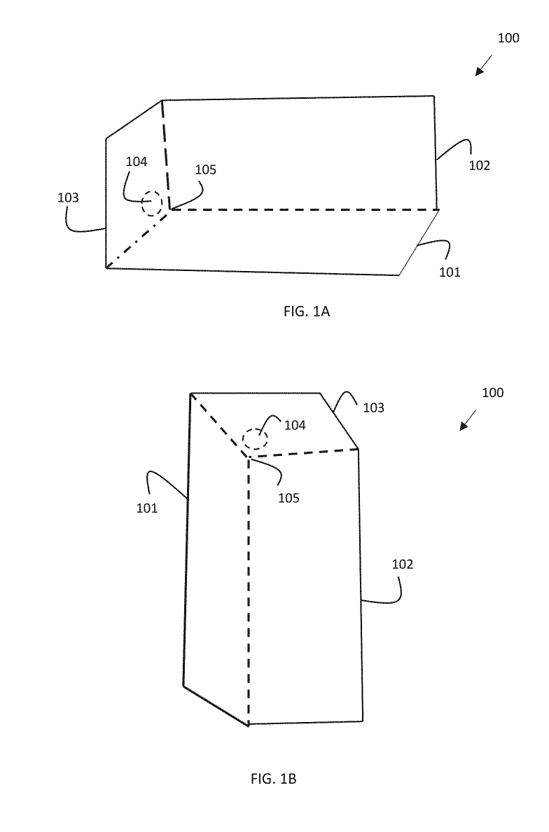

FIG. 1A is front and side view of a UV light inhibiting (shielding) apparatus 100, according to an example embodiment.

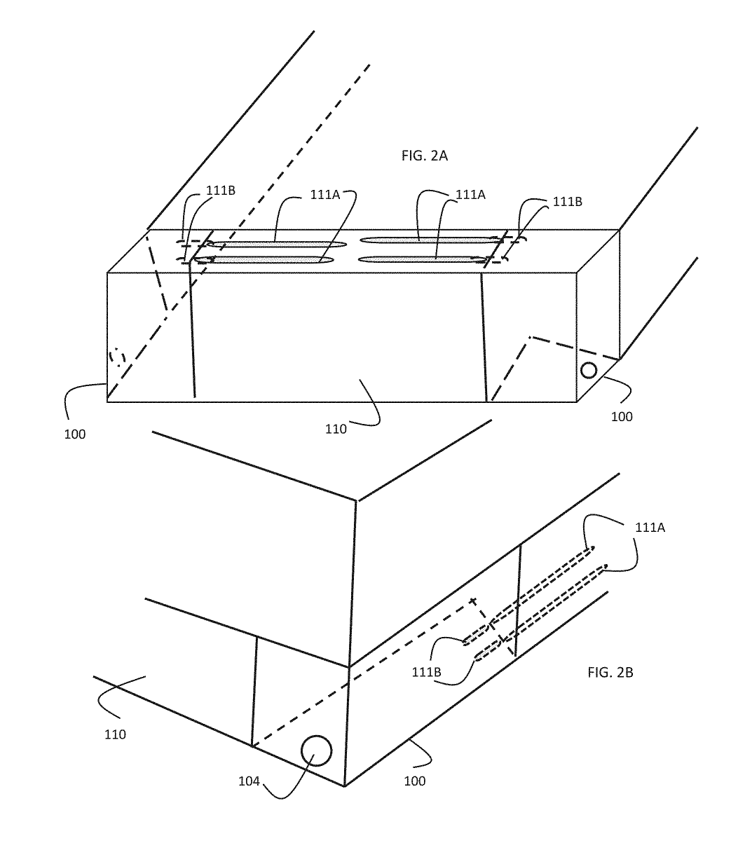

As will be more completely demonstrated herein and below, UV shielding apparatuses 100 are attached to front corners of a UV curing device for purposes of preventing UV leakage from the UV bulbs illuminated from a front and a bottom of the UV curing device during curing of a UV coating applied to a surface (such as flooring) (depicted in FIGS. 2A-2B, 3A-3B, and 4 below). This makes UV coated surface applications more efficient and practical while improving the quality in the cured UV coating on the surface.

The UV shielding apparatus 100 includes a first side 101, a shield side 102, an attachment side 103 having an attachment aperture 104, and a joining intersection 105.

In an embodiment, the first side 101, the shield side 102, and the attachment side are welded to one another along their edges that intersect as a joint at the joining intersection 105.

In an embodiment, the material of the first side 101, the shield side 102, and the attachment side 103 is stainless steel that is approximately 62/1000^{TH} inch thick.

In an embodiment, the material of the first side 101, the shield side 102 and the attachment side 103 is a material and a material thickness that are capable of withstanding heat in the range of (700-900 degrees Celsius) without melting or deforming.

The first side 101 and the shield side 102 are of the same length. The creates a welded seam between the first side 101 and the shield side 102, which is of import because of the high degree of heat that emanates from the UV bulbs of the UV curing device creating an even seal between the welded seam and a bottom and side surface of the UV curing device to which the UV shielding apparatus 100 is attached through the attachment side 103 and an attachment mechanism inserted through the attachment aperture 104.

The attachment side 103 is welded along two edges to an edge of the first side 101 and an edge of the shield side 102, such that: 1) the first side 101 is welded along a first edge to a first edge of the shield side 102 creating a first welded seam; 2) a first edge of the attachment side 103 is welded to a second edge of the first side 101 creating a second welded seam; and a second edge of the attachment side 103 is welded second edge of the shield side 102 creating a third seam.

The attachment side 103 is of a shorter length than that which is associated with the first side 101 and the shield side 102.

In an embodiment the attachment side 103 is of a same height of that which is associated with the first side 101 and the shield side 102.

In an embodiment, a ratio of the length of the first side 101 and the shield side 102 to the length of the attachment side 103 is approximately 5 to 2.

The length and height of the first side 101, the shield side 102, and the attachment side 103 are configured and manufactured based on dimensions of the UV curing device to which UV shielding apparatuses 100 are being attached to and length and placement of the UV bulbs relative to front and bottom ends of the UV curing device.

In an embodiment, the UV curing device is the curing device distributed as Tiger® having 10 inch UV curing bulbs, where the length of the first side 101 and the shield side 102 is 5 inches, the height of the first side 101 and the shield side 102 is 2 inches, and the length and height of the attachment side 103 are 2 inches by 2 inches.

In an embodiment, the UV curing device is the curing device distributed as Jelight® having 12 inch UV curing bulbs, where the length and height of the first side 101 and the shield side 102 are 5 inches by 2 inches, and the length and height of the attachment side 103 is 2 inches by 2 inches.

In an embodiment, the length of the first side 101 and the shield side 102 is a function of a length of the UV bulb(s) manufactured in the front and bottom of the UV curing device. In an embodiment, the function is such that the length of shield side 101 covers approximately 1 inch of the ends of UV bulb(s).

In an embodiment, the first side 101 and the shield side 102 of a same height.

In an embodiment, the shield side 102 is of a greater height than a height for the first side 101.

In an embodiment, the height of the shield side 102 is greater than the heights of both the first side 101 and the attachment side 103. In an embodiment, the heights of the first side 101 and the attachment side 103 are a same height.

In an embodiment, the heights and lengths of the sides 101-103 are configured or manufactured to shield or inhibit UV light leakage from the front and sides of UV bulbs illuminated from a front and bottom of a UV curing device. That is, any variation from what was described above in the dimensions of the sides 101-103 may be used as long as the resulting UV shielding apparatus 100 shields or inhibits UV light leakage from a UV curing device.

The attachment aperture 104 matches an aperture in a front side of the UV curing device, such aperture in the UV curing device can be pre-manufactured with the UV curing device to match and align with the attachment aperture 104 or such aperture in the UV curing device can be post-manufacture drilled into a covering of the front and side of the UV curing device and aligned with the attachment aperture 104.

In an embodiment, the attachment aperture 104 is approximately ⅛^{th} of an inch.

Any attachment mechanism can be used though the attachment aperture 104 to attach and seal the UV shielding apparatus 100 to a front and side of the UV curing device. In an embodiment, the attachment mechanism is a screw having a same or slightly smaller diameter than a diameter of the attachment aperture 104 and to which a bolt is inserted through the aperture of the UV curing device through the attachment aperture 104 and a bolt (such as a butterfly bolt) is screwed onto the bolt to adhere, fix, attached, and seal, the UV shielding apparatus 100 to one front-side corner portion of the UV curing apparatus. Another UV shielding apparatus 100 is similarly adhered, fixed, attached, and sealed to the other front-side corner portion of the UV curing device.

The FIG. 1B is a different view of the UV light inhibiting apparatus from that which is shown in the FIG. 1A, according to an example embodiment. The FIG. 1B illustrates the UV shielding (inhibiting) apparatus 100 of the FIG. 1A stood up along an edge of the first side 101 and the shield side 102.

It is noted that the orientation of the UV shielding apparatus 100 can be flipped such that the first side 101 becomes the shield side 102 and the shield side 102 becomes the first side 101. For instance, when the UV shielding apparatus 100 is attached to a font and side of a UV curing device to a front-right corner (when facing the UV curing device), the first side 101 is the shield side and the shield side 102 is the first side 101. The discussion of the FIG. 1A was from an orientation of a front-left corner (when facing the UV curing device). A single manufactured UV shielding apparatus 100 can be adhered and sealed to either front-corner (left or right) of the UV curing device. Thus, there is no difference between which side 101 or 102 is used to shield (inhibit) the UV light illuminated from the UV bulbs.

FIG. 2A is a view of UV light inhibiting apparatuses 100 attached to the sides of a UV curing device with a bottom perspective of the UV curing apparatus, according to an example embodiment.

The front of the UV curing device is shown with the UV curing device 110 flipped over so as to visualize the bottom of the UV curing device 110.

The UV curing device 110 includes a plurality of UV bulbs 111 A (mercury-based that is heated inside the bulb 111A to create a plasma) that illuminate UV light and the surface of the bulbs 111A of a very high heat (700-900 degrees Celsius).

Two UV shielding apparatuses 100 are attached in the manner shown (through an attachment mechanism utilizing the attachment aperture 104 of each UV shielding apparatus 100. The shield side 102 of each UV shielding apparatus 100 covers a portion of the bottom surface of the UV curing device 110 from the front corners. The length of the covering ensures that at least a portion 111B of the UV bulbs are covered by the shield side on both ends. In an embodiment, the length of the covered portion 111B of the UV bulbs 111A is approximately 1 inch.

In an embodiment, the length of the covered portion 111B is greater than 1 inch but less than 2 inches.

In an embodiment, the length of the covered portion 111B is substantially 1 inch with a preconfigured amount whereby the length of the covered portion 111B is slightly less than 1 inch.

FIG. 2B is a view of one the UV light inhibiting apparatus attached to one corner side of a UV curing device with top-down perspective of the UV curing device, according to an example embodiment.

The FIG. 2B shows an attached UV shielding apparatus 100 to a front-left corner of a UV curing device 110. This also illustrates that the attachment aperture 104, in an embodiment, is situated at a side-front corner of the UV curing device 110, which creates a better seal of the UV shielding apparatus 100 to the UV curing device 110 along the joint 105 of the UV shielding apparatus 100.

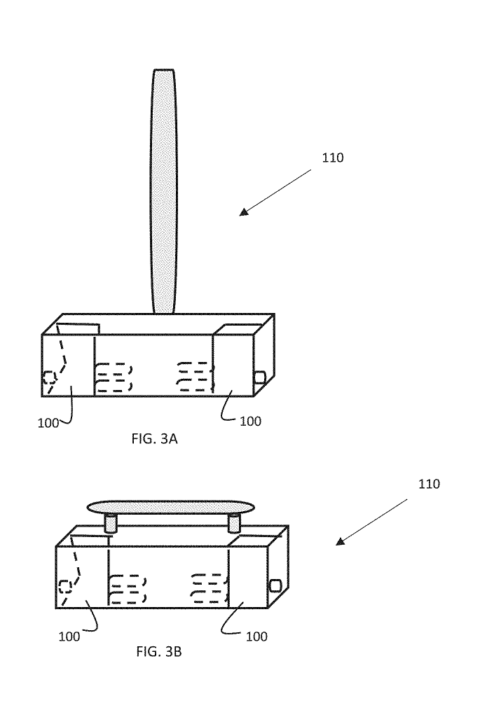

FIG. 3A is a diagram of a UV curing device having two attached the UV light inhibiting apparatuses, according to an example embodiment.

The FIG. 3A illustrates a push operated UV curing device 110 having a handle in which the operator pushes to maneuver the UV curing device 110 over a surface (floor) on which a UV coating is being cured by the UV bulbs 111A that are illuminated along a front-bottom surface of the UV curing device 110. The front left and right corners have attached UV shielding apparatuses 100.

FIG. 3B is a diagram of another UV curing device having two attached the UV light inhibiting apparatuses, according to an example embodiment.

The FIG. 3B illustrates another type of UV curing device 110 in which an operator uses a different type of handle to maneuver the UV curing device 110 along a surface on which UV coating is being cured. This type of UV curing device 110 illustrated is often referred to as a handheld UV curing device 110. Again, the front left and right corners of the UV curing device 110 have attached UV shielding apparatuses 100.

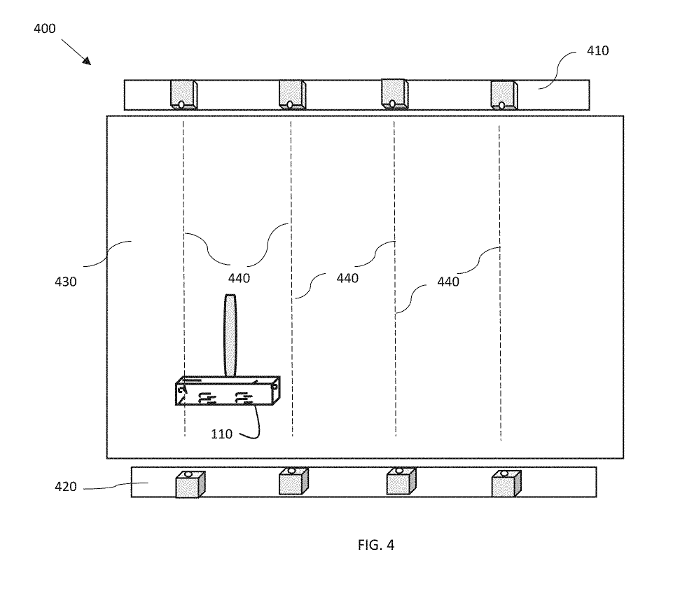

FIG. 4 is a diagram of a system 400 for using UV light inhibiting apparatuses attached or integrated into a UV curing device to cure a UV coating on a surface, according to an example embodiment.

The system 400 includes two laser mapping apparatuses 410 and 420, each having a plurality of lasers that illuminate laser lines 440 along a surface (floor) 430. The system 400 also includes a UV curing device 110 having attached to its front (left and right sides) two UV shielding apparatus 100.

The laser lines 440 illuminated from the lasers of the first laser mapping apparatus 410 align with the laser lines 440 that are illuminated from the second (opposing) laser mapping apparatus 420. This provides navigation for an operator of the UV curing device 110 when curing a UV coating applied to the surface 430.

The UV curing device 110 includes a crosshair guide affixed on the front of the UV curing device 110 which an operator aligns with one of the laser line 440 (the line 440 facing towards the operator, the overlapping line 440 will be blocked by the back of the operator) and the operator pushes the UV curing device 110 towards the laser line 440 while maintaining the laser line 440 aligned with the crosshair guide of the UV curing device 110.

When the UV curing device 110 includes 10 inch bulbs 111A, the lasers of each apparatus 410 and 420 are spaced apart from one another at a distance of 9 inches. The overlapping portion 111B of the bulbs 111A is one inch, such that with this arrangement on each pass over the surface made by the operator with the UV curing device a portion of the surface 430 is overlapped by 2 inches as the operator passes back over the line 440 on a different side of the line 440 from that which was passed over when the operator was headed in the opposite direction. That is, when the operator is headed towards a line 440 illuminated by a laser of apparatus 410 (with the line 440 on the right of the operator) and then is returning headed towards (in an opposite direction) a line 440 illuminated by a laser of apparatus 420 (with the line 440 still on the right of the operator) while maintaining the crosshair as guide with the laser lines 440, approximately 2 inches of the surface is overlapped (and cured) on each pass from what was done on the prior pass.

The distance of the aligned lasers in the apparatuses 410 and 420 is dependent upon the size of the bulbs 111A and the length of the portion 111B of the bulbs 111A that the UV shielding apparatuses 100 cover.

In an embodiment, the UV shielding apparatuses 100 are premanufactured with the manufacture of the UV curing device 110, such that a novel UV curing device 110 is presented that includes the UV shielding apparatuses 100.

In an embodiment, the UV shielding apparatuses 100 are installed on the UV curing device 110 after manufacture of the UV curing device 110. In this embodiment, the UV shielding apparatuses 100 are detachable, removable, and re-attachable to the UV curing device 110.

One now appreciates how UV shielding apparatuses 100 can be made and installed (if necessary) to create a novel UV curing device 110 that can be operated in a manner described in the system 400 to create improved UV coating applications that have heretofore been unrealized in the industry due to prohibitive cost, application, quality, and time considerations.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. § 1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. An apparatus, comprising:
a first Ultraviolet (UV) shielding apparatus adapted to attach to a front and left-side corner of a UV curing device and cover a first portion of UV bulbs; and
a second UV shielding apparatus adapted to attach to a front and right-side corner of the UV curing device and cover a second portion of the UV bulbs.

2. The apparatus of claim 1, wherein the first UV shielding apparatus includes a first aperture adapted to receive a first attachment mechanism to seal the first UV shielding apparatus to the front and left-side corner of the UV curing device, and wherein the second UV shielding apparatus includes a second aperture adapted to receive a second attachment mechanism to seal the second UV shielding apparatus to the front and right-side corner of the UV curing device.

3. The apparatus of claim 1, wherein the first and second apertures have diameters of approximately ⅛^{th} of an inch.

4. The apparatus of claim 1, wherein the apparatus is a material that can withstand temperatures in a range of 700-900 degrees Celsius.

5. The apparatus of claim 4, wherein the material is stainless steel having a thickness of approximately 62/1000^{th} of an inch.

6. The apparatus of claim 1, wherein each of the first and second UV shielding apparatuses includes three sides with two of the three sides being of a same length and height, and a remaining side of the three sides having a same height as the height of the two sides and the remaining side having a length that is smaller than the length of the two sides.

7. The apparatus of claim 6, wherein for each of the UV shielding apparatuses: the two sides are welded together to create a first seam along a common edge.

8. The apparatus of claim 7, wherein for each of the UV shielding apparatuses: the remaining side is welded to a second edge of one of the two sides to create a second seam, and a different edge of the remaining side is welded to a second edge of a remaining one of the two sides to create a third seam.

9. The apparatus of claim 8, wherein for each of the UV shielding apparatuses: an aperture is adjacent to an intersection of the first, the second, and third seams on the remaining side.

10. An Ultraviolet (UV) curing device, comprising:
a UV base having a plurality of UV bulbs;
a first UV shielding apparatus that covers a first portion of one or more of the UV bulbs from a front-left corner of the UV base; and
a second UV shielding apparatus that covers a second portion of one or more of the UV bulbs from a front-right corner of the UV base.

11. The UV curing device of claim 10, wherein the first and second portions cover one or more of the UV bulbs by a length of approximately 1 inch.

12. The UV curing device of claim 10, wherein the first and second UV shielding apparatuses are adapted to be attached and to be detached from the UV base.

13. The UV curing device of claim 10, wherein the first and second UV shielding apparatuses are manufactured and integrated units with the UV base.

14. The UV curing device of claim 10, wherein the UV curing device includes a handle that is adapted to push the UV curing device while an operator is standing upright behind the UV curing device.

15. The UV curing device of claim 10, wherein the UV curing device includes a handle that is adapted to operate the UV curing device while an operated is standing along a side or over the UV curing device.

16. A system, comprising:
a laser mapping apparatus comprising opposing sets of lasers, each opposing set aligned and overlapping with one another, the lasers project laser lines across a surface; and
an Ultraviolet (UV) curing device having a first UV shielding device attached to a front-left side of the UV curing device and a second UV shielding device attached to a front-right side of the UV curing device;
wherein the UV curing device is adapted to be operated for following the laser lines when curing a UV coating that is coated on the surface.

17. The system of claim 16, wherein the UV curing device includes a crosshair alignment mechanism adapted to align with any one of the laser lines during operation of the UV curing device.

18. The system of claim 16, wherein the UV curing device includes a handle for operating the UV curing device while standing behind and pushing the UV curing device.

19. The system of claim 16, wherein the UV curing device includes a handle for operating the UV curing device while standing over or along a side of the UV curing device.

20. The system of claim 16, wherein the first and the second UV shielding apparatuses are adapted to be detached from the UV curing device and adapted to be re-attached to the UV curing device.
